(19) United States
(12) Patent Application Publication
(10) Pub. No.: US 2025/0355726 A1
(43) Pub. Date: Nov. 20, 2025

(54) Workload Management Hardware Using Hardware Thermal Sensor Data

(71) Applicant: International Business Machines Corporation, Armonk, NY (US)

(72) Inventors: Andrew C. M. Hicks, Highland, NY (US); Desmond Fitzpatrick, Ossining, NY (US); Marc Henri Coq, Hopewell Junction, NY (US); Luiz C. Alves, Hopewell Junction, NY (US); William J. Clarke, Poughkeepsie, NY (US); Richard Charles Brown, Poughkeepsie, NY (US); Chunming Lin, Poughkeepsie, NY (US); Brian Charles Tucker, Clinton Corners, NY (US)

(21) Appl. No.: 18/666,007

(22) Filed: May 16, 2024

(51) Int. Cl. G06F 9/50

(52) U.S. Cl. CPC G06F 9/5094; G06F 9/5044

(57) ABSTRACT

A computer implemented method manages computing workloads. A processor set monitors thermal data from sensors associated with a set of components in a computer system. The processor set manages computing workloads for the set of components using the thermal data and a policy defining component usage.

### BACKGROUND

The disclosure relates generally to an improved computer system and more specifically to distributing workloads to physical hardware.

Energy efficiency and sustainability are increasing focuses in designing and operating computer systems. Increasing energy efficiency includes reducing energy use during the operation of computer systems. The reduction in energy use can occur through using low-power hardware components and implementing power management strategies to manage hardware components in computer systems. Increasing sustainability in computing systems includes reducing the environmental impact of the computer systems. The environmental impact can be reduced through green manufacturing practices, repair and recycling initiatives, and extending the lifecycle of hardware components in the computer systems.

### SUMMARY

According to one illustrative embodiment, a computer implemented method manages computing workloads. A processor set monitors thermal data from sensors associated with a set of components in a computer system. The processor set manages computing workloads for the set of components using the thermal data and a policy defining component usage. According to other illustrative embodiments, a computer system and a computer program product for managing computing workloads are provided.

### BRIEF DESCRIPTION OF THE DRAWINGS

FIG. 1 is a block diagram of a computing environment in accordance with an illustrative embodiment;

FIG. 2 is a block diagram of a workload environment in accordance with an illustrative embodiment;

FIG. 3 is a block diagram of processing of thermal data in accordance with an illustrative embodiment;

FIGS. 4A and 4B are a flowchart of a process for computing workloads in accordance with an illustrative embodiment;

FIG. 5 is a flowchart of a process for computing workloads in accordance with an illustrative embodiment;

FIG. 6 is a flowchart of a process for managing computing in accordance with an illustrative embodiment;

FIG. 7 is a flowchart of a process for managing computing workloads in accordance with an illustrative embodiment;

FIG. 8 is a flowchart of a process for managing computing workloads using thermal wear and a policy in accordance with an illustrative embodiment;

FIG. 9 is a flowchart of a process for determining remaining life for the set of components in accordance with an illustrative embodiment;

FIG. 10 is a flowchart of a process for managing computing workloads in accordance with an illustrative embodiment; and

FIG. 11 is a block diagram of a data processing system in accordance with an illustrative embodiment.

### DETAILED DESCRIPTION

A computer implemented method manages computing workloads. A processor set monitors thermal data from sensors associated with a set of components in a computer system. The processor set manages computing workloads for the set of components using the thermal data and a policy defining component usage. As a result, the illustrative embodiments provide a technical effect of managing workloads using thermal data and a policy that can increase at least one of energy efficiency, sustainability, availability, or reliability of the components.

In the illustrative embodiments, as part of managing the computing workloads, the processor set can increase an availability of a component in the set of components using the thermal data and the policy defining component usage based on the thermal data. As a result, the illustrative embodiments provide a technical effect of increasing the availability of a component.

In the illustrative embodiments, as part of managing the computing workloads, the processor set can distribute the computing workloads to the set of components using the thermal data and the policy defining component usage based on the thermal data. As a result, the illustrative embodiments provide a technical effect of distributing computing workloads to components using thermal data and a policy defining component usage based on the thermal data.

In the illustrative embodiments, the policy can comprise a set of rules selected from at least one of a reliability, an availability, a serviceability profile, a threshold temperature range, sustainability, or wear leveling. As a result, the illustrative embodiments provide a technical effect of providing a policy to manager workloads using in a manner that that increases at least one of energy efficiency, sustainability, availability, or reliability.

In the illustrative embodiments, the processor set can determine a thermal wear for the set of components using the thermal data. Also, as part of managing the computing workloads, the processor set can manage the computing workloads for the set of components using the thermal wear determined from the thermal data and the policy defining component usage. As a result, the illustrative embodiments provide a technical effect of managing components using thermal wear determined from the thermal data and a policy defining component usage.

In the illustrative embodiments, the processor set can determine a thermal wear for the set of components using the thermal data. The processor set can determine a remaining life for the set of components from the thermal wear. As a result, the illustrative embodiments provide a technical effect of determining a remaining life for components.

In the illustrative embodiments, as part of managing the computing workloads, the processor set can manage the computing workloads for the set of components using the remaining life for the set of components determined from the thermal data and the policy defining component usage. As a result, the illustrative embodiments provide a technical effect of managing components using the remaining life for the components.

In the illustrative embodiments, the policy can assign a critical workload a component with a higher remaining life than another component in the set of components. As a result, the illustrative embodiments provide a technical effect of assigning a critical work to a component with a higher remaining life.

In the illustrative embodiments, the processor set can monitor thermal data and manage computing workloads in response to detecting that a sustainability power-saving mode has been activated. As a result, the illustrative embodiments provide a technical effect of monitoring thermal data and managing computing works loads in response activation of a sustainability power-saving mode.

In the illustrative embodiments, the thermal data can comprise at least one of a temperature, a heat sink temperature, a power usage, an electrical current, an applied voltage, or a fan speed. As a result, the illustrative embodiments provide a technical effect of using thermal data comprising at least one of a temperature, a heat sink temperature, a power usage, an electrical current, an applied voltage, or a fan speed.

In the illustrative embodiments, the set of components can be selected from at least one of a computer, a router, a switch, an adapter card, an I/O card, a network interface card, a processor unit, a hard drive, a solid state drive, an I/O drawer, a power supply, a regulator card, a fan, a water circulation pump, a motor drive, a high performance computing system, an edge computing system, an autonomous computing system, a quantum computing system, a data center, or a disaster recovery system. As a result, the illustrative embodiments provide a technical effect of managing workloads for components selected from at least one of a computer, a router, a switch, an adapter card, an I/O card, a network interface card, a processor unit, a hard drive, a solid state drive, an I/O drawer, a power supply, a regulator card, a fan, a water circulation pump, a motor drive, a high performance computing system, an edge computing system, an autonomous computing system, a quantum computing system, a data center, or a disaster recovery system.

A computer system comprises a processor set, a set of one or more computer-readable storage media, and program instructions. The program instructions are collectively stored in the set of one or more storage media. The program instructions cause the processor set to perform computer operations. The program instructions cause the processor set to monitor thermal data from sensors associated with a set of components in the computer system. The program instructions cause the processor set to manage computing workloads for the set of components using the thermal data and a policy defining component usage. As a result, the illustrative embodiments provide a technical effect of managing workloads using thermal data and a policy that can increase at least one of energy efficiency, sustainability, availability, or reliability of the components.

In the illustrative embodiments, as part of distributing the computing workloads, the program instructions, collectively stored in the set of one or more storage media, can cause the processor set to increase an availability of a component in the set of components using the thermal data and the policy defining component usage based on the thermal data. As a result, the illustrative embodiments provide a technical effect of increasing the availability of a component.

In the illustrative embodiments, as part of managing the computing workloads, the program instructions, collectively stored in the set of one or more storage media, can cause the processor set to distribute the computing workloads to the set of components using the thermal data and the policy defining component usage based on the thermal data. As a result, the illustrative embodiments provide a technical effect of distributing computing workloads to components using thermal data and a policy defining component usage based on the thermal data.

In the illustrative embodiments, the policy can comprise a set of rules is selected from at least one of a reliability, an availability, and a serviceability profile; a threshold temperature range; sustainability, or wear leveling. As a result, the illustrative embodiments provide a technical effect of providing a policy to manager workloads using in a manner that that increases at least one of energy efficiency, sustainability, availability, or reliability.

In the illustrative embodiments, the program instructions, collectively stored in the set of one or more storage media, can further cause the processor set to determine a thermal wear for the set of components using the thermal data. A part of managing the computing workloads, the program instructions, collectively stored in the set of one or more storage media, can further cause the processor set to manage the computing workloads for the set of components using the thermal wear determined from the thermal data and the policy defining component usage. As a result, the illustrative embodiments provide a technical effect of managing components using thermal wear determined from the thermal data and the policy defining component usage.

In the illustrative embodiments, the program instructions, collectively stored in the set of one or more storage media, can further cause the processor set to determine a thermal wear for the set of components using the thermal data. The program instructions, collectively stored in the set of one or more storage media, can further cause the processor set to determine a remaining life for the set of components from the thermal wear. As a result, the illustrative embodiments provide a technical effect of determining a remaining life for components.

In the illustrative embodiments, as part of managing computing workloads, the program instructions, collectively stored in the set of one or more storage media, can cause the processor set to manage the computing workloads for the set of components using the remaining life for the set of components determined from the thermal data and the policy defining component usage. As a result, the illustrative embodiments provide a technical effect of managing components using the remaining life for the components.

In the illustrative embodiments, the policy can assign a critical workload a component with a higher remaining life than another component in the set of components. As a result, the illustrative embodiments provide a technical effect of assigning a critical work to a component with a higher remaining life.

A computer program product manages computing workloads. The computer program product comprises a set of one or more computer-readable storage media; program instructions, collectively stored in the set of one or more storage media, for causing a processor set to perform computer operations: The program instructions, collectively stored in the set of one or more storage media, cause a processor set to monitor thermal data from sensors associated with a set of components in a computer system. The program instructions, collectively stored in the set of one or more storage media, cause a processor set to manage the computing workloads for the set of components using the thermal data and a policy defining component usage. As a result, the illustrative embodiments provide a technical effect of managing workloads using thermal data and a policy that can increase at least one of energy efficiency, sustainability, availability, or reliability of the components.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

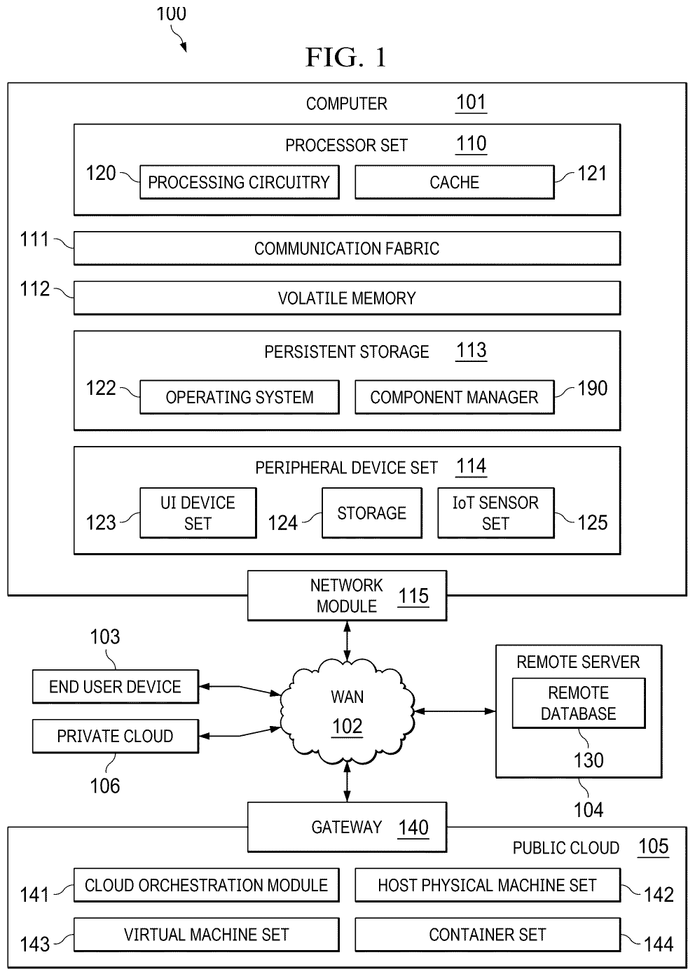

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as component manager 190. In this example, component manager 190 can operate to increase at least one of energy efficiency, sustainability, availability, or reliability of hardware components in computing environment 100. In addition to component manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and component manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in component manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in component manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, redundancy is present in components such as power supplies, central processors, local memory, input/output boards, network adapters, and other components. The amount of redundancy in computer systems can increase the amount of power consumption. Another source of inefficiencies in power use involves configuring computer systems with a larger capacity than needed for actual client workloads.

Computer systems with hardware components that enter long-term idle or power down states can have component longevity issues. For example, excessive thermal cycling of components can occur for components that are brought into and out of service. For example, some computer systems may be used for disaster recovery purposes. These types of computer systems may be powered on, but not for long periods of time.

Stress can occur to processors, memory, and other integrated circuits from powering these components on and off. Asymmetrical wear can also occur when some components are primary components that are always called on first to perform a function or a service while backup components are underutilized or never powered on for use.

Thermal sensors associated with components in computer systems can be used to measure the temperature of hardware components. These measurements are thermal data that can be integrated over time. This processing of thermal data can generate wear information that indicates which components have lesser amounts of thermal stress over the lifetime of the components.

This type of information can be used to indicate when underutilized components in a computer system should be brought into rotation to even wear on components within the computer system. This information can also be used to calculate the remaining life of the component. This type of action can be used for field spare stocking, proactive replacement, or risk assessment. Also, this information can also be used to determine whether selected components have a higher risk of failure as compared to other components. This type of information can be used to select components with a lower risk of failure when critical or important workloads are present for which a failure of components is undesirable. For example, critical workloads may be present on particular days during which a failure of a component used to process the critical workloads can be reduced through selecting components with a lower risk of failure.

Thus, illustrative examples provide a method, apparatus, computer system, and computer program product for distributing workloads. In one illustrative example, a computer implemented method manages computing workloads. Monitoring of thermal data from sensors associated with a set of components in a computer system is performed. Computing workloads for the set of components are managed using the thermal data and a policy defining component usage. This policy can be used to achieve various at least one of energy efficiency, sustainability, availability, or reliability with respect to the components being managed through the computing workloads.

Further, the phrase “at least one of,” when used with a list of items, means different combinations of one or more of the listed items can be used, and only one of each item in the list may be needed. In other words, “at least one of”' means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of”' can be, for example, without limitation, two of item A; one of item B; and ten of item C; four of item B and seven of item C; or other suitable combinations.

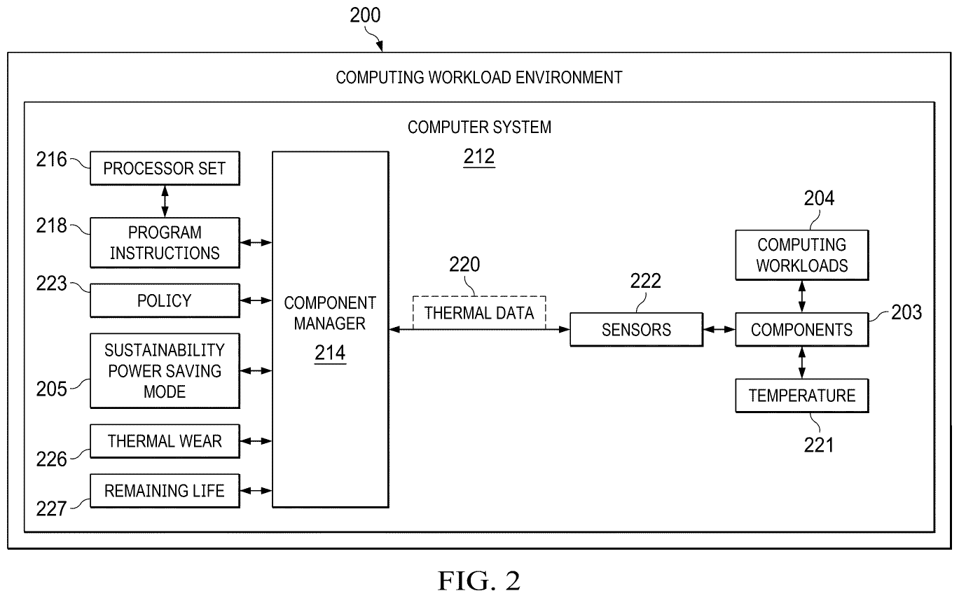

With reference now to FIG. 2, a block diagram of a workload environment is depicted in accordance with an illustrative embodiment. In this illustrative example, computing workload environment 200 includes components that can be implemented in hardware such as the hardware shown in computing environment 100 in FIG. 1. In this example, component manager 214 in computing workload environment 200 can operate to manage a set of components 203 in computer system 212. In this illustrative example, the management of components 203 is managing computing workloads 204 that are performed by components 203. In this example, this management of components can be performed in a number of different ways. For example, the management can be performed continuously. In other illustrative examples, this management of components 203 can be performed in response to detecting that sustainability power saving mode 205 has been activated.

As used herein, a “set of” when used with reference to items means one or more items. For example, a set of components 203 is one or more of components 203.

In this illustrative example, computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes processor set 216 that is capable of executing program instructions 218 implementing processes in the illustrative examples. In other words, program instructions 218 are computer-readable program instructions. Processor set 216 is an example of processor set 110 in FIG. 1.

As used herein, a processor unit in processor set 216 is a hardware device and is comprised of hardware circuits such as those on an integrated circuit that respond to and process instructions and program code that operate a computer. Processor set 216 can be a number of processor units and can be implemented using processor set 110 in FIG. 1. The processor units can also be referred to as computer processors.

When processor set 216 executes program instructions 218 for a process, processor set 216 can be one or more processor units that are in the same computer or in different computers. In other words, the process can be distributed between processor units in processor set 216 on the same or different computers in computer system 212.

Further, processor set 216 can include the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 216 can also include other components in addition to the processor units or processing circuitry. For example, processor set 216 can also include a cache or other components used with processor units or other processing circuitry.

In these illustrative examples, the set of components 203 are one or more hardware components within computer system 212. Components 203 can include at least one of a computer, a router, a switch, an adapter card, an I/O card, a network interface card, a processor unit, a hard drive, a solid state drive, an I/O drawer, a power supply, a regulator card, a fan, a water circulation pump, a motor drive, a high performance computing system, an edge computing system, an autonomous computing system, a quantum computing system, a data center, a disaster recovery system, or other components in computer system 212.

In these examples, computer system 212 with component manager 214 can be implemented to manage components 203 in a number of different types of platforms. For example, computer system 212 with component manager 214 can be located in a platform selected from a group comprising a manufacturing plant, a power plant, a dam, an automobile, a train, a ship, an aircraft, a satellite, a space station, a building, a hospital, industrial equipment, or some other platform in which components 203 are used.

Components 203 can take different forms depending on the platform. For example, in a hospital, components 203 can be selected from at least one of a computer, an x-ray machine, a surgical robot, a defibrillator, a computer tomography (CT) scanner, an infusion pump, an ultrasound machine, or other suitable components that are found in a hospital. As another example, in an automobile assembly plant, components 203 can be selected from at least one of a conveyor system, a robotic arm, a welding robot, a robotic gripper, a laser cutter, an automated riveting tool, or other suitable components.

In this illustrative example, computing workloads 204 are workloads that can be run on components 203. Computing workloads 204 when run on a component in components 203 drives dynamic thermal loads within computer system 212. The dynamic thermal loads are thermal loads that can change based on the type of computing workload. For example, some computing workloads are performed to keep a component, such as a server, up and running. Other computing workloads are for applications, services, or other processes that perform functions or computations using the component. In this illustrative example, computing workloads 204 for keeping a component up and running result in a thermal load that is lighter than computing workloads 204 for an application.

As depicted, component manager 214 can be implemented using component manager 190 in FIG. 1. Component manager 214 can be implemented in software, hardware, firmware, or a combination thereof. When software is used, the operations performed by component manager 214 can be implemented in program instructions configured to run on hardware, such as a processor unit. When firmware is used, the operations performed by component manager 214 can be implemented in program instructions and data and stored in persistent memory to run on a processor unit. When hardware is employed, the hardware can include circuits that operate to perform the operations in component manager 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

In this illustrative example, component manager 214 monitors thermal data 220 from sensors 222 associated with a set of components 203 in computer system 212. In this illustrative example, thermal data 220 comprises data for characteristics relating to temperature 221 for the set of components 203. These characteristics can be direct measurements of temperature or indirect measurements that are derived from other data in the thermal data 220 measured by sensors 222.

For example, sensors 222 can make measurements of at least one of power usage, current flow, applied voltage, or other measurements that form thermal data 220. These measurements are measurements that can be used to determine the temperature for components 203. Thus, the measurements used to generate thermal data 220 can be direct or indirect measurements of temperature for the set of components 203.

Sensors 222 are hardware devices and can take a number of different forms. For example, sensors 222 can include at least one of a thermal couple, a temperature sensor, an infrared sensor, an electrical current sensor, a power sensor, and other suitable types of sensors.

In this illustrative example, component manager 214 manages computing workloads 204 for the set of components 203 using thermal data 220 and policy 223 defining component usage. Policy 223 is a set of rules and can include information or data used to apply the set of rules. These rules can be created based on various goals including at least one of availability, reliability, or sustainability of hardware components. For example, policy 223 can include one or more types of rules selected from a at least one of a reliability, availability, and serviceability (RAS) profile, a threshold temperature range, sustainability, wear leveling, or other types of rules for use in managing computing workloads 204 for components 203.

In this example, a reliability, availability, and serviceability profile is a set of rules based on metrics that components 203 should meet. These rules can be used to distribute computing workloads 204 to components 203 to meet these metrics.

With sustainability, policy 223 can include rules relating to energy use and heat generation by components 203. For example, policy 223 can specify that computing workloads 204 are distributed to components 203 in a manner that reduces energy use. In one example, a rule may specify that when two components are used to provide the same service, a first component may receive more computing workloads than the second component when the second component consumes more energy in performing the same computing workloads.

A temperature threshold range can be used to distribute computing workloads 204 in a manner such that the set of components 203 operate within the temperature threshold range. In another example, wear leveling can include rules that operate the set of components 203 such that the wear for components 203 that perform computing workloads 204 are within some threshold or within some range relative to each other. This type of rule can result in evening wear between those components.

For example, component manager 214 can determine a thermal wear 226 for the set of components 203 using thermal data 220. With the determination of thermal wear 226, component manager 214 can manage computing workloads 204 for the set of components 203 using thermal wear 226 determined from thermal data 220 and policy 223 defining component usage. Thermal wear 226 can be based on thermal stress over time caused by at least one of thermal cycling or sustained periods of time at high temperatures.

In this example, thermal wear 226 can be, for example, degradation of components 203 occurring in response to temperatures affecting those components. This degradation can result in at least one of a reduction in availability or reliability. In determining thermal wear 226 for a component, the temperature from heat generated by the component or from heat generated by other components near the component can be measured to form thermal data 220 and used to determine thermal wear 226.

In another illustrative example, component manager 214 can measure remaining life 227 for the set of components 203 from thermal wear 226. In this example, component manager 214 manages computing workloads 204 for the set of components 203 using remaining life 227 for the set of components and policy 223 defining component usage.

For example, underutilized components in components 203 having a higher remaining life can be used based on policy 223. In one example, policy 223 can assign a critical computing workload to a component with a higher remaining life than another component in the set of components 203. As result, increased availability can be present for critical computing workloads with this type of computing workload assignment.

In another illustrative example, component manager 214 can increase an availability of a component in the set of components 203 using thermal data with policy 223. With this example, policy 223 includes rules on availability of the set of components 203 to perform computing workloads 204 based on component usage. For example, policy 223 can include one or more rules indicating that component usage should result in even wear between components 203 to meet sustainability goals. Thus, the availability of components 203 can be selected to even the wearer usage between components 203. Further, availability of some components in the set of components 203 can be increased in response to a critical workload or a critical period of time for processing computing workloads 204. In this case, the availability of components in the set of components 203 with at least one of lower thermal loads or lower thermal wear can be increased.

In yet another illustrative example, policy 223 can be used by component manager 214 to distribute computing workloads 204 to the set of components 203 using thermal data 220 and policy 223 based on thermal data 220. In this example, thermal data 220 can be used to identify components in the set of components 203 with lower computing workloads when distributing new computing workloads to the set of components 203. Thermal data 220 can be selected from at least one of temperature, a heat sink temperature, a power usage, an electrical current, an applied voltage sensor, a fan speed, or other measurements that can be used to identify temperature of components 203.

For example, the set of components 203 can be edge servers in computer system 212 that are used to process transactions. Thermal data 220 can indicate which of the edge servers are processing lower levels of computing workloads 204 based on the temperatures identified using thermal data 220. In this example, lower temperatures indicate that lower levels of computing workloads 204 are being performed by those edge servers. As a result, component manager 214 can distribute computing workloads 204 to those edge servers with lower computing workloads based on the temperatures identified using thermal data 220.

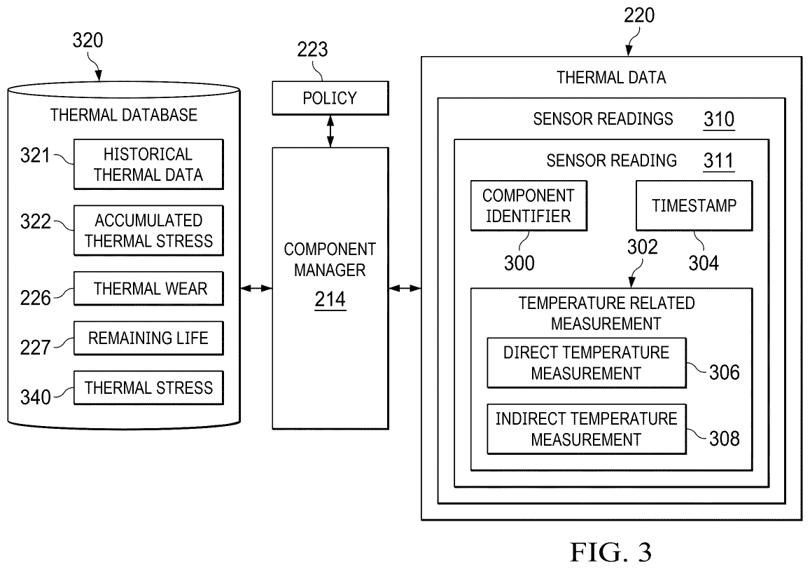

With reference next to FIG. 3, a block diagram of processing of thermal data is depicted in accordance with an illustrative embodiment. In the illustrative examples, the same reference numeral may be used in more than one figure. This reuse of a reference numeral in different figures represents the same element in the different figures.

In this example, thermal data 220 is received by component manager 214 from sensors 222. In this example, thermal data 220 comprises sensor readings 310 for the set of components 203 in FIG. 2. Sensor readings 310 can include a number of different types of information. For example, sensor reading 311 in sensor readings 310 is for a component in the set of components 203. As depicted, sensor readings 310 comprises component identifier 300, temperature related measurement 302, and timestamp 304.

In this example, component identifier 300 identifies a particular component in components 203 for which sensor reading 311 is made. Temperature related measurement 302 is a measurement of temperature for the component. Temperature related measurement 302 can take a number of different forms. For example, temperature related measurement 302 can be direct temperature measurement 306 or indirect temperature measurement 308 of temperature.

In this example, direct temperature measurement 306 is a measurement of a temperature for the component. Indirect temperature measurement 308 is a measurement of parameters that can be used to derive, infer, or otherwise determine the temperature. For example, indirect temperature measurement 308 can be at least one of power usage, an electrical current, an applied voltage sensor, a fan speed, or other measurement that can be used to determine temperature for a component.

In sensor reading 311, timestamp 304 identifies a date and time at which temperature related measurement 302 was made. This timestamp can be used with other sensor readings to identify an order of measurements for analysis.

In this illustrative example, sensor reading 311 can be processed in real time to manage computing workloads 204 for the set of components. For example, temperature related measurement 302 can be compared to a temperature range that is used to adjust computing workloads 204 for the component in real time.

In one illustrative example, sensor readings 310 for a component can be used to determine a derivative of temperature with respect to time. This calculation can be used to determine a rate of change of temperature. This information can also be used with policy 223 to manage computing workloads 204 for the component.

In another example, sensor reading 311 can be stored in thermal database 320 with other previously received sensor readings to form historical thermal data 321. Historical thermal data 321 can include a history of temperatures measured for components 203. As another example, historical thermal data 321 can also include a rate of change in temperatures over time. This type of information can be analyzed to identify which components may have higher stresses based on the rate of change in temperature. This thermal database can include accumulated field operating data for components and actual component failure rates over time. This information can be used to set policy 223.

In this example, thermal stress 340 is a profile for a component that describes the thermal stress that the component has encountered over time. Thermal stress 340 can be calculated from sensor readings 310 of components 203. Thermal stress 340 can be caused by one of thermal cycling for sustained periods of high temperature for the components. In one illustrative example, thermal stress 340 can be determined using a model of thermal power that describes temperature resulting from power sent into a component.

This thermal stress can be tracked over time to identify accumulated thermal stress 322 for a component. Accumulated thermal stress 322 is the cumulative effect of at least one of repeated or sustained thermal exposure on a component. This accumulated thermal stress can be used to determine thermal wear 226.

At least one of thermal wear 226 or accumulated thermal stress 322 can be used with policy 223 to achieve wear leveling. Further, this information can also be used to identify remaining life 227. Remaining life 227 can then be used to identify components for use in situations in which high-availability and high reliability are needed to process computing workloads 204.

This and other information can be used to perform a number of different actions in addition to managing computing workloads 204. For example, these actions can include at least one of spare stocking, corrective component replacement, risk assessment, maintenance, or other suitable action.

The illustration of sensor readings 310 in this figure is provided as an example and not meant to limit other data that may be present in sensor readings 310. For example, sensor reading 311 can include other measurements in addition to temperature related measurement 302. For example, measurements of on/off power cycling count, environmental humidity, and atmospheric quality can also be present in sensor reading 311. Atmospheric quality can be measured using detectors such as corrosion sensors that indicate how long a component has been running in a high-risk environment such as those caused by local combustion of high-sulfur fuels.

In the illustrative examples, these measurements can be used with the other measurements in creating collections of information for components 203. These collections of information can be analyzed to determine reliability data for components 203. This reliability data can be combined with the other measurements in generating profiles for the components. These profiles can be used with policy 223 to distribute computing workloads. Further, these profiles can also be used to perform other actions such as determining a maintenance or replacement schedule. The profiles can also be used to select new components.

Computer system 212 can be configured to perform at least one of the steps, operations, or actions described in the different illustrative examples using software, hardware, firmware, or a combination thereof. As a result, computer system 212 operates as a special purpose computer system in which component manager 214 in computer system 212 enables managing computing workloads 204 for components 203. In particular, component manager 214 transforms computer system 212 into a special purpose computer system as compared to currently available general computer systems that do not have component manager 214.

Further, in the illustrative example, the use of component manager 214 in computer system 212 integrates processes into a practical application for managing computing workloads 204 performed by components 203. This management increases the performance of computer system 212 with respect to at least one of improved sustainability, availability, or energy efficiency. In other words, component manager 214 in computer system 212 is directed to a practical application of processes integrated into component manager 214 in computer system 212 that monitors thermal data 220 and manages computing workloads 204 using thermal data 220 and policy 223. Further, these different steps cannot be practically performed by a person. A person cannot practically manage different components in a computing system in a manner that provides the availability and sustainability as quickly as needed to provide desired sustainability, energy efficiency, and availability of components 203 to perform different computing actions in computer system 212.

Thus, illustrative embodiments provide a computer implemented method, computer system, and computer program product for managing computing workloads. The use of component manager 214 in FIG. 2 can increase the ability to manage components in a computer system to increase energy efficiency and sustainability. This management can also increase the availability and reliability of components in a computer system. In these examples, the management is performed based on thermal data detected for the component and a policy for managing computing workloads for the component.

The type of computing workload management can take into account concerns with excessive thermal cycling and asymmetrical wear to components. This information also can be used to identify redundant or underutilized components that can be placed into rotation to level thermal wear across components 203 in computer system 212. Further as described in these illustrative examples, components 203 with a lower risk of failure can be used when computing workloads 204 require enhanced or higher levels of availability and reliability.

The illustration of computing workload environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, component manager 214 can manage components in other computer systems in addition to or in place of computer system 212. In another illustrative example, component manager 214 can include distributed components that perform processing on multiple processors or computers in computer system 212.]

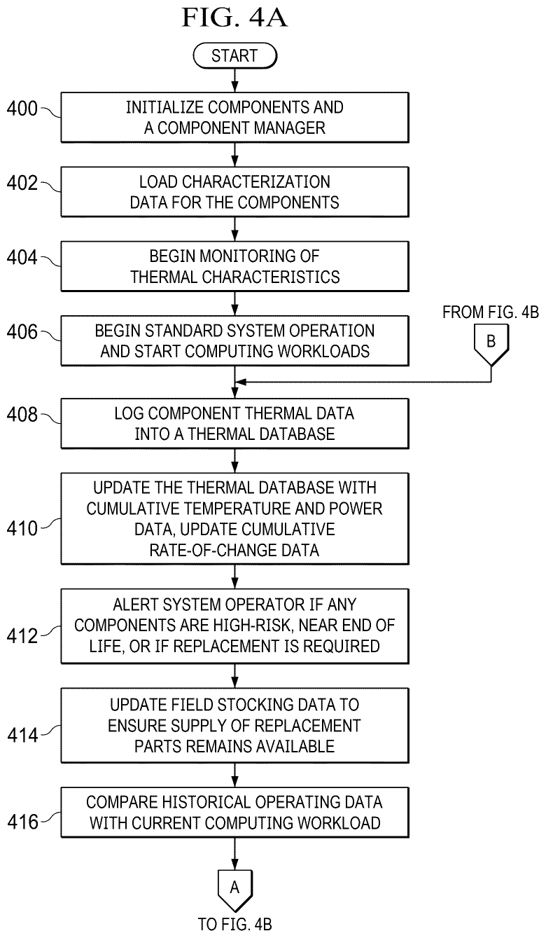

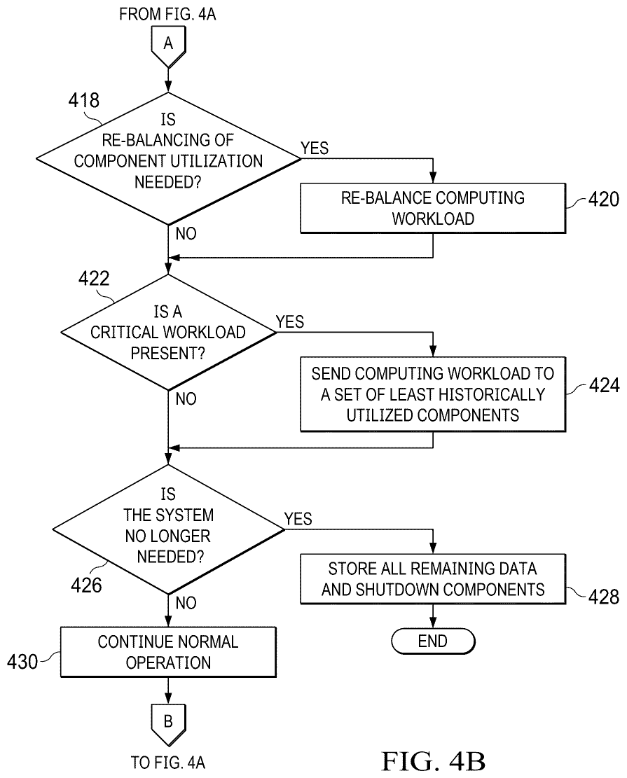

Turning next to FIGS. 4A and 4B, a flowchart of a process for computing workloads is depicted in accordance with an illustrative embodiment. The process in FIG. 4 can be implemented in hardware, software, or both. When implemented in software, the process can take the form of program instructions that are run by a processor set located in one or more hardware devices in one or more computer systems. For example, the process can be implemented in component manager 214 in computer system 212 in FIG. 2.

The process begins by initializing components and a component manager (step 400). In step 400 initialization of components includes components in the computer system being managed as well as other components used to monitor the components being managed. For example, monitoring hardware such as a sensor system can also be initialized in step 400.

The process loads characterization data for the components (step 402). In step 402, the characterization data indicates how different components resources are affected by the environment. In these illustrative examples, characterization data of interest is thermal characteristics data. This type of data can include power consumption, how components are affected by thermal stresses, power consumption, and other characteristics about the component relating to heat generation and exposure to heat. For example, the characterization data can include how power is used, resources used, temperature, and other information about the components. The characterization data can be determined during the design and testing process.

This characterization data can be used to direct the flow of computing workloads in a path through different components. The particular path can be based on how different components are affected by thermal stresses. The characterization data can be different for components of the same type. Characterization data can be associated with components using serial numbers or other unique identifiers for the components.

The process begins monitoring thermal characteristics (step 404). In step 404, the thermal characteristics data are measurements that indicate the temperature of a component. These measurements can include temperatures measured for the components and can also include power use, fan speed, and other measurements that can be used to determine the temperature of a component. These measurements are used to generate thermal data relating to the generation of heat by the components.

The process begins standard system operation and starts computing workloads (step 406). In this example, the computer system begins operation to process computer workloads. The process logs thermal data (step 408). In step 408, the thermal data is received from monitoring thermal characteristics in step 404.

The process updates the thermal database with cumulative temperature, power data, and cumulative rate of change data (step 410). In step 410, this information can be determined from the historical thermal data stored in a thermal database.

The process alerts the system operator if any components are high-risk, near the end of life, or replacement is required (operation 412). This determination can be made using a policy for the component.

The process updates field stocking data to ensure a supply of replacement parts remains available (step 414). Further, the process compares historical operating data with the current computing workload (step 416). In step 416 existing, known, reliability data from failed components in conjunction with operating data from the application in which the failed components were utilized is used to create a model from which remaining lifespan of the existing componentry can be determined.

The process determines whether rebalancing of component utilization is needed (step 418). This determination in step 418 can be made using a policy. For example, a network adapter card running at extended periods of time at 70 degrees C. has experienced a failure at 2000 hours of operation. Also, an underutilized network adapter card sitting at 45 degrees C. has not been failing. The policy can specify moving a computing workload to the cooler underutilized network adapter card to extend life of the first network adapter card. In addition to rebalancing computing workloads, the policy can also suggest replacing a network adapter card operating at 70 degrees C. after 1750 hours rather than waiting for failure to occur.

If rebalancing is needed, the process rebalances the computing workload (step 420). In step 420, the rebalancing can be performed based on the policy to meet various metrics such as evening wear, increasing sustainability, energy efficiency, or other goals.

The process determines whether a critical workload is present (422). The process also proceeds to step 422 from step 418 if rebalancing is not needed. If the critical workloads are present, the process sends the computing workload to a set of least historically utilized components (step 424). The process then determines whether the system is no longer needed (step 426). In step 426, the process determines whether the system in which the components are still needed. In this example, the system is the computer system with the components being monitored.

If the system is no longer needed, the process stores remaining data and shuts down the components (step 428). The process terminates thereafter. With reference again to step 426, if the system is still needed, the process continues normal operation step 430. The process then returns to step 408.

With reference again to step 422, if the critical workload is not present, the process proceeds to step 426 as described above. Turning back to step 418, if rebalancing of component utilization is not needed, the process proceeds to step 422.

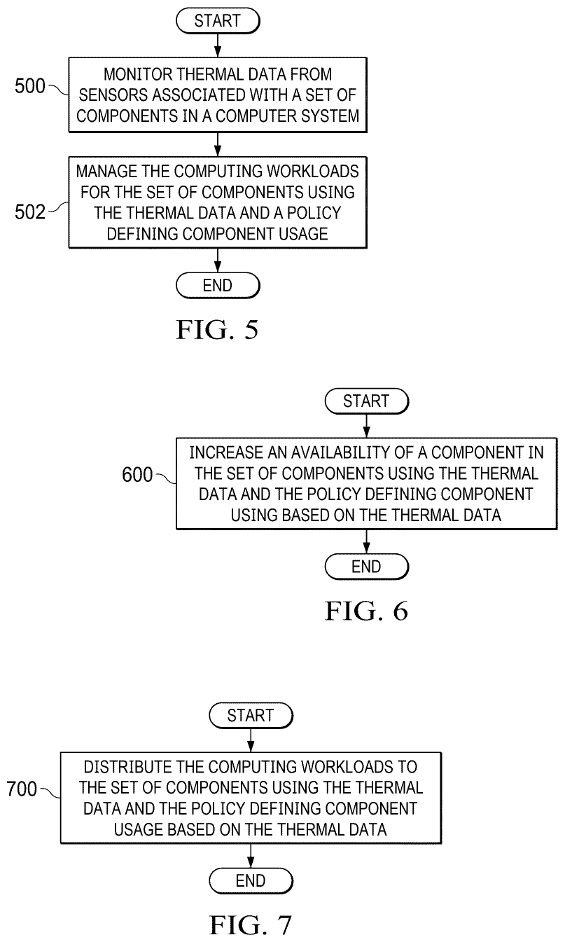

Next in FIG. 5, a flowchart of a process for computing workloads is depicted in accordance with an illustrative embodiment. The process in FIG. 5 can be implemented in hardware, software, or both. When implemented in software, the process can take the form of program instructions that are run by a processor set located in one or more hardware devices in one or more computer systems. For example, the process can be implemented in component manager 214 in computer system 212 in FIG. 2.

The process monitors thermal data from sensors associated with a set of components in a computer system (step 500). In step 500, thermal data can comprise at least one of a temperature, a heat sink temperature, a power usage, an electrical current, an applied voltage, a fan speed, or other suitable parameter.

The process manages the computing workloads for the set of components using the thermal data and a policy defining component usage (step 502). The process terminates thereafter.

In this illustrative example, the process in FIG. 5 can be performed continuously or in response to certain conditions. For example, the monitoring in step 500 and the managing in step 502 can be performed in response to detecting that a sustainability power-saving mode has been activated.

With reference now to FIG. 6, a flowchart of a process for managing computing workloads is depicted in accordance with an illustrative embodiment. The process in this figure is an example of an implementation for step 502 in FIG. 5.

The process increases an availability of a component in the set of components using the thermal data and the policy defining component usage based on the thermal data (step 600). The process terminates thereafter.

Turning to FIG. 7, a flowchart of a process for managing computing workloads is depicted in accordance with an illustrative embodiment. The process in this figure is an example of an implementation for step 502 in FIG. 5.

The process distributes the computing workloads to the set of components using the thermal data and the policy defining component usage based on the thermal data (step 700). The process terminates thereafter.

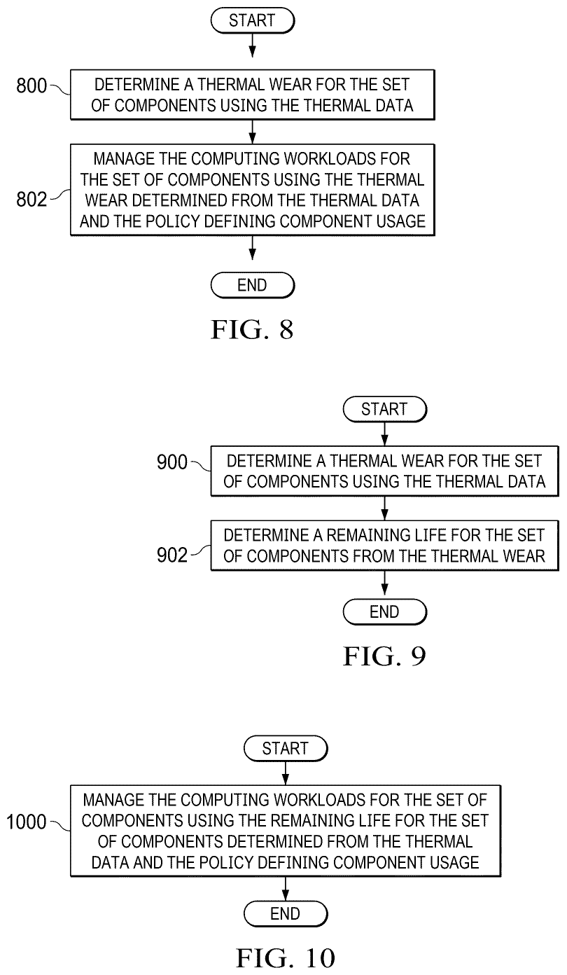

In FIG. 8, a flowchart of a process for managing computing workloads using thermal wear and a policy is depicted in accordance with an illustrative embodiment. The steps in this figure are an example of an implementation for step 502 in FIG. 5.

The process determines a thermal wear for the set of components using the thermal data (step 800). The process manages the computing workloads for the set of components using the thermal wear determined from the thermal data and the policy defining component usage (step 802). The process terminates thereafter.

Turning next to FIG. 9, a flowchart of a process for determining remaining life for the set of components is depicted in accordance with an illustrative embodiment. The steps in this figure are an example of additional steps that can be performed with the steps in FIG. 5.

The process determines a thermal wear for the set of components using the thermal data (step 900). The process determines a remaining life for the set of components from the thermal wear (step 902). The process terminates thereafter.

In FIG. 10, a flowchart of a process for managing computing workloads is depicted in accordance with an illustrative embodiment. The steps in this figure are an example of an implementation for step 502 in FIG. 5 using the thermal wear determined in FIG. 9.

The process manages the computing workloads for the set of components using the remaining life for the set of components determined from the thermal data and the policy defining component usage (step 1000). The process terminates thereafter. In this example, with the determination of thermal wear, a policy can assign a critical workload to a component with a higher remaining life than another component in the set of components.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

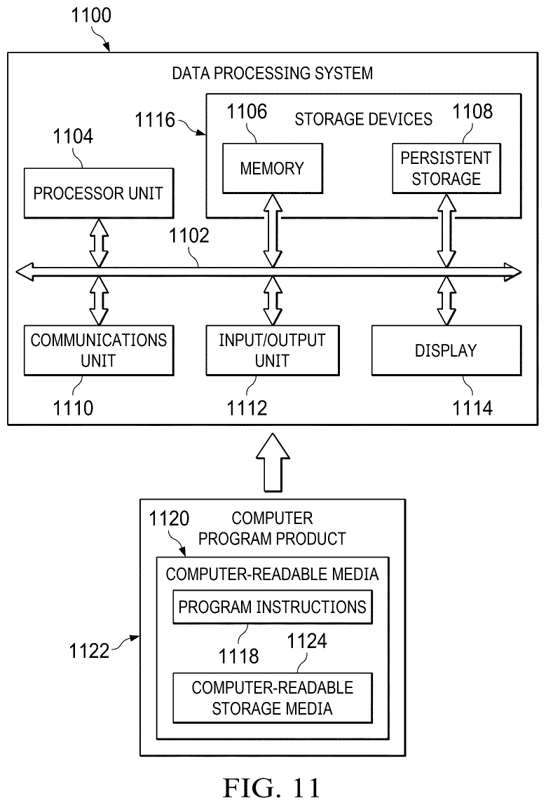

Turning now to FIG. 11, a block diagram of a data processing system is depicted in accordance with an illustrative embodiment. Data processing system 1100 can be used to implement computers and computing devices in computing environment 100 in FIG. 1. Data processing system 1100 can also be used to implement computer system 212 in FIG. 2. In this illustrative example, data processing system 1100 includes communications framework 1102, which provides communications between processor unit 1104, memory 1106, persistent storage 1108, communications unit 1110, input/output (I/O) unit 1112, and display 1114. In this example, communications framework 1102 takes the form of a bus system.

Processor unit 1104 serves to execute instructions for software that can be loaded into memory 1106. Processor unit 1104 includes one or more processors. For example, processor unit 1104 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1104 can be implemented using one or more heterogeneous processor systems in which a main processor is present with secondary processors on a single chip. As another illustrative example, processor unit 1104 can be a symmetric multi-processor system containing multiple processors of the same type on a single chip.

Memory 1106 and persistent storage 1108 are examples of storage devices 1116. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1116 may also be referred to as computer-readable storage devices in these illustrative examples. Memory 1106, in these examples, can be, for example, a random-access memory or any other suitable volatile or non-volatile storage device. Persistent storage 1108 may take various forms, depending on the particular implementation.

For example, persistent storage 1108 may contain one or more components or devices. For example, persistent storage 1108 can be a hard drive, a solid-state drive (SSD), a flash memory, a rewritable optical disk, a rewritable magnetic tape, or some combination of the above. The media used by persistent storage 1108 also can be removable. For example, a removable hard drive can be used for persistent storage 1108.

Communications unit 1110, in these illustrative examples, provides for communications with other data processing systems or devices. In these illustrative examples, communications unit 1110 is a network interface card.

Input/output unit 1112 allows for input and output of data with other devices that can be connected to data processing system 1100. For example, input/output unit 1112 may provide a connection for user input through at least one of a keyboard, a mouse, or some other suitable input device. Further, input/output unit 1112 may send output to a printer. Display 1114 provides a mechanism to display information to a user.

Instructions for at least one of the operating system, applications, or programs can be located in storage devices 1116, which are in communication with processor unit 1104 through communications framework 1102. The processes of the different embodiments can be performed by processor unit 1104 using computer-implemented instructions, which may be located in a memory, such as memory 1106.

These instructions are referred to as program instructions, computer usable program instructions, or computer-readable program instructions that can be read and executed by a processor in processor unit 1104. The program instructions in the different embodiments can be embodied on different physical or computer-readable storage media, such as memory 1106 or persistent storage 1108.

Program instructions 1118 are located in a functional form on computer-readable media 1120 that is selectively removable and can be loaded onto or transferred to data processing system 1100 for execution by processor unit 1104. Program instructions 1118 and computer-readable media 1120 form computer program product 1122 in these illustrative examples. In the illustrative example, computer-readable media 1120 is computer-readable storage media 1124.

Computer-readable storage media 1124 is a physical or tangible storage device used to store program instructions 1118 rather than a medium that propagates or transmits program instructions 1118. Computer-readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1118 can be transferred to data processing system 1100 using a computer-readable signal media. The computer-readable signal media are signals and can be, for example, a propagated data signal containing program instructions 1118. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1120” can be singular or plural. For example, program instructions 1118 can be located in computer-readable media 1120 in the form of a single storage device or system. In another example, program instructions 1118 can be located in computer-readable media 1120 that is distributed in multiple data processing systems. In other words, some instructions in program instructions 1118 can be located in one data processing system while other instructions in program instructions 1118 can be located in another data processing system. For example, a portion of program instructions 1118 can be located in computer-readable media 1120 in a server computer while another portion of program instructions 1118 can be located in computer-readable media 1120 located in a set of client computers.

The different components illustrated for data processing system 1100 are not meant to provide architectural limitations to the manner in which different embodiments can be implemented. In some illustrative examples, one or more of the components may be incorporated in or otherwise form a portion of, another component. For example, memory 1106, or portions thereof, may be incorporated in processor unit 1104 in some illustrative examples. In other examples, more than one processor unit can be present. The different illustrative embodiments can be implemented in a data processing system including components in addition to or in place of those illustrated for data processing system 1100. Other components shown in FIG. 11 can be varied from the illustrative examples shown. The different embodiments can be implemented using any hardware device or system capable of running program instructions 1118.

Thus, illustrative embodiments provide a computer implemented method, computer system, and computer program product for managing computing workloads. In one illustrative example, a computer implemented method manages computing workloads. A processor set monitors thermal data from sensors associated with a set of components in a computer system. The processor set manages computing workloads for the set of components using the thermal data and a policy defining component usage.

In the illustrative example, the use of component manager 214 in FIG. 2 can increase the ability to manage components in a computer system to increase energy efficiency and sustainability. This management can also increase the availability and reliability of components in a computer system. In these examples, the management is performed based on thermal data detected for the component and a policy for managing computing workloads for the component.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for managing computing workloads, the computer implemented method comprising:
monitoring, by a processor set, thermal data from sensors associated with a set of components in a computer system; and
managing, by the processor set, the computing workloads for the set of components using the thermal data and a policy defining component usage.

2. The computer implemented method of claim 1, wherein managing, by the processor set, the computing workloads comprises:
increasing, by the processor set, an availability of a component in the set of components using the thermal data and the policy defining component usage based on the thermal data.

3. The computer implemented method of claim 1, wherein managing, by the processor set, the computing workloads comprises:
distributing, by the processor set, the computing workloads to the set of components using the thermal data and the policy defining component usage based on the thermal data.

4. The computer implemented method of claim 1, wherein the policy comprises a set of rules selected from at least one of a reliability, an availability, a serviceability profile, a threshold temperature range, sustainability, or wear leveling.

5. The computer implemented method of claim 1 further comprising:
determining, by the processor set, a thermal wear for the set of components using the thermal data,
wherein managing, by the processor set, the computing workloads comprises:
managing, by the processor set, the computing workloads for the set of components using the thermal wear determined from the thermal data and the policy defining component usage.

6. The computer implemented method of claim 1 further comprising:
determining, by the processor set, a thermal wear for the set of components using the thermal data; and
determining, by the processor set, a remaining life for the set of components from the thermal wear.

7. The computer implemented method of claim 6, wherein managing, by the processor set, the computing workloads comprises:
managing, by the processor set, the computing workloads for the set of components using the remaining life for the set of components determined from the thermal data and the policy defining component usage.

8. The computer implemented method of claim 6, wherein the policy assigns a critical workload a component with a higher remaining life than another component in the set of components.

9. The computer implemented method of claim 1, wherein monitoring, by a processor set, thermal data and managing, by the processor set, the computing workloads are performed in response to detecting activation of a sustainability power-saving mode.

10. The computer implemented method of claim 1, wherein the thermal data comprises at least one of a temperature, a heat sink temperature, a power usage, an electrical current, an applied voltage, or a fan speed.

11. The computer implemented method of claim 1, wherein the set of components is selected from at least one of a computer, a router, a switch, an adapter card, an I/O card, a network interface card, a processor unit, a hard drive, a solid state drive, an I/O drawer, a power supply, a regulator card, a fan, a water circulation pump, a motor drive, a high performance computing system, an edge computing system, an autonomous computing system, a quantum computing system, a data center, or a disaster recovery system.

12. A computer system comprising:
a processor set, a set of one or more computer-readable storage media, and program instructions, collectively stored in the set of one or more storage media, for causing the processor set to perform the following computer operations:
monitor thermal data from sensors associated with a set of components in the computer system; and
manage computing workloads for the set of components using the thermal data and a policy defining component usage.

13. The computer system of claim 12, wherein in managing the computing workloads, the program instructions, collectively stored in the set of one or more storage media, cause the processor set to perform the following computer operations:
increase an availability of a component in the set of components using the thermal data and the policy defining component usage based on the thermal data.

14. The computer system of claim 12, wherein in managing the computing workloads, the program instructions, collectively stored in the set of one or more storage media, cause the processor set to perform the following computer operations:
distribute the computing workloads to the set of components using the thermal data and the policy defining component usage based on the thermal data.

15. The computer system of claim 12, wherein the policy comprises a set of rules is selected from a at least one of a reliability, an availability, and a serviceability profile; a threshold temperature range; sustainability, or wear leveling.

16. The computer system of claim 12, wherein the program instructions, collectively stored in the set of one or more storage media, further cause the processor set to perform the following computer operations:
determine a thermal wear for the set of components using the thermal data; and wherein in managing, by the processor set, computing workloads, the program instructions, collectively stored in the set of one or more storage media, further cause the processor set to perform the following computer operations:
manage the computing workloads for the set of components using the thermal wear determined from the thermal data and the policy defining component usage.

17. The computer system of claim 12, wherein the program instructions, collectively stored in the set of one or more storage media, further cause the processor set to perform the following computer operations:
determine a thermal wear for the set of components using the thermal data; and
determine a remaining life for the set of components from the thermal wear.

18. The computer system of claim 17, wherein in managing computing workloads, the program instructions, collectively stored in the set of one or more storage media, cause the processor set to perform the following computer operations:
manage the computing workloads for the set of components using the remaining life for the set of components determined from the thermal data and the policy defining component usage.

19. The computer system of claim 17, wherein the policy assigns a critical workload a component with a higher remaining life than another component in the set of components.

20. A computer program product for managing computing workloads, the computer program product comprising:
a set of one or more computer-readable storage media;
program instructions, collectively stored in the set of one or more storage media, for causing a processor set to perform the following computer operations:
monitor thermal data from sensors associated with a set of components in a computer system; and
manage the computing workloads for the set of components using the thermal data and a policy defining component usage.
